(19) United States
(12) Patent Application Publication
(10) Pub. No.: US 2017/0262955 A1
(43) Pub. Date: Sep. 14, 2017

(54) Scene-Aware Power Manager For GPU

(71) Applicant: MediaTek Inc., Hsinchu City (TW)

(72) Inventors: Yuan-Chun Lin, Taichung City (TW); Wen-Shan Tsou, Hsinchu City (TW); Jiun-Yuan Wu, Hsinchu City (TW)

(21) Appl. No.: 15/606,132

(22) Filed: May 26, 2017

(51) Int. Cl. G06T 1/20; G06T 15/00

(52) U.S. Cl. CPC G06T 1/20; G06T 15/005; G06F 1/3296

(57) ABSTRACT

Apparatus and methods are disclosed for managing power consumption of a graphics processing system. Specifically, the method adaptively adjusts the performance level of the graphics processing system based on scene information in each frame. A scene-aware power manager is configured to receive scene information and adaptively control performance of the GPU according to the received scene information. The power manager compares the early indicators of the current frame with the early indicators of a previous frame to determine a level of scene change and to assign a set of initial performance settings based on the determined level of scene change.

### TECHNICAL FIELD

The present disclosure is generally related to video display in electronic apparatus and, more particularly, to power management at a graphical processing unit.

### BACKGROUND

Unless otherwise indicated herein, approaches described in this section are not prior art to the claims listed below and are not admitted as prior art by inclusion in this section.

A graphical processing unit (GPU) (also occasionally called VPU, or visual processing unit) is a specialized electronic circuit designed to rapidly manipulate and alter memory to accelerate the creation of images in a frame buffer intended for output to a display. GPUs are used in embedded systems, mobile phones, personal computers, workstations, and game consoles. Modern GPUs are very efficient at manipulating computer graphics and image processing, and their highly parallel structure make them more efficient than general purpose CPUs for algorithms where the processing of large blocks of data is done in parallel.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the present disclosure provide apparatus and methods for managing power consumption of a graphics processing system. Specifically, the method adaptively adjusts the performance level of the graphics processing system based on scene information in each frame. In some embodiments, such adjustment aims to optimize the performance level of the graphics processing system.

In some embodiments, a graphics processing system includes a graphical processing unit (GPU) and a scene-aware power manager that is coupled to the graphical processing unit. The scene-aware power manager is configured to receive scene information and adaptively control performance of the GPU according to the received scene information.

In some embodiments, the scene information includes a set of early indicators of an upcoming frame. The power manager compares the early indicators of the current frame with the early indicators of a previous frame to determine a level of scene change and to assign a set of initial performance settings based on the determined level of scene change. The power manager uses the assigned set of initial performance settings to set the performance of the graphics processing system before the start of a frame. In some embodiments, if the level of scene change is sufficiently small, the power manager would increment or decrement the performance settings from the previous frame by a small amount as the initial performance of the new current frame.

In some embodiments, the power manager adjusts the performance settings further in a fine-grained fashion. The power manager re-evaluates or re-estimates the level of scene change at certain event or operational steps. Upon occurrence of these steps or events, the power manager compares the scene information with a set of previously recorded scene information to re-estimate the level of scene change. This previously recorded scene information can be scene information of a previous frame, or of a previous event or operational step. The power manager then uses the re-estimated level of scene change to determine a new performance setting.

In some embodiments, each reported event or operational step is associated with a timestamp that marks the event's actual time of occurrence, and the power manager compares this actual time of occurrence with an expected time of occurrence in order to determine a fine-grain adjustment of the performance settings.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation in order to clearly illustrate the concept of the present disclosure.

FIG. 1 illustrates a graphics processing system that has a scene-aware power manager for managing the performance of the graphical process circuit.

FIG. 2 illustrates the adjustment or the setting of performance in the graphics processing system by a power manager.

FIG. 3 conceptually illustrates a process for managing power in a graphics processing system.

FIG. 4 is a block diagram of the graphics processing system that includes CPU, GPU, memory, and display devices.

FIGS. 5a-b illustrates the flow of data in the graphics processing system when using a performance LUT to lookup performance settings for various devices.

FIG. 6 illustrates fine-grain adjustment of performance settings for processing a frame based on timestamps of monitored events.

FIG. 7 illustrates the data flow in the graphics processing system when it performs fine-grain performance settings adjustment based on event timestamps.

FIG. 8 conceptually illustrates an electronic system in which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Some embodiments disclose methods and apparatus for managing power consumption of a graphics processing system. Specifically, the method adaptively adjusts the performance level of the graphics processing system based on scene information in each frame. In some embodiments, such adjustment aims to optimize the performance level of the graphics processing system. For some embodiments, optimal performance settings for a frame is one at which the graphics processing system completes the workload of the frame just before the end of the frame, thereby wastes the least amount of power. (The frames are dropped when operating at a performance level lower than necessary to finish the workloads on time. The circuit wastes power when operating at a performance level higher than necessary to finish the workload on time.)

In some embodiments, a graphics processing system includes a graphical processing unit (GPU) and a scene-aware power manager that is coupled to the GPU. The scene-aware power manager is configured to receive scene information and adaptively control performance of the GPU according to the received scene information.

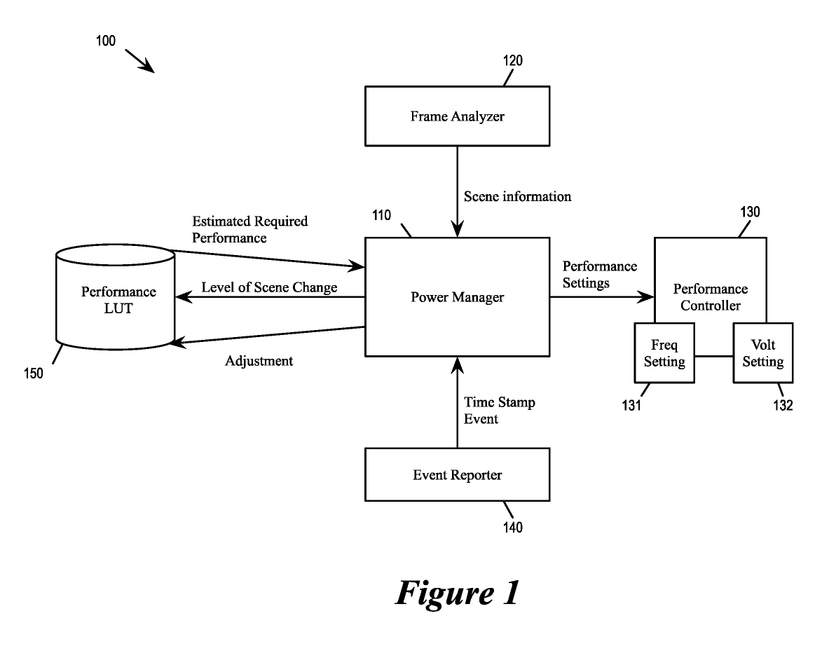

FIG. 1 illustrates a graphics processing system 100 that has a scene-aware power manager 110 for managing the performance of the graphics processing system. The power manager 110 derives scene information from data collected from various devices in the graphics processing system 100 and adjusts the performance settings of the graphics processing system accordingly.

The graphics processing system 100 is an electronic device having components capable of processing data and generating data for graphics display. Such a device can be a generic computing device such as a desktop computer, laptop computer, tablet computer, smartphone, etc. that includes central processing units (CPU), memory components, input/output devices, network interfaces, user interfaces, etc. Such a device can also be equipped with hardware such as GPU that are specialized for processing graphical data. The electronic device serving as the graphics processing system 100 may also perform functions that are unrelated to graphics.

The graphics processing system 100 includes the power manager 110, a frame analyzer 120, a performance controller 130, a scene information storage 140, a performance lookup table (LUT) 150, and an event reporter 160. The power manager 110 receives data from the frame analyzer 120 as scene information and determines the performance settings to the performance controller 130 based on the received scene information. The power manager 110 detects a level of scene change from the received scene information (by e.g., comparing it with the received scene information from a previous frame) and uses the detected level of scene change to lookup an estimated required performance from the performance lookup table 150. The power manager 110 uses the estimated required performance to produce the performance settings to the performance controller 130.

In some embodiments, such performance settings include a frequency setting 131 and a voltage setting 132. The voltage setting 132 indicates a voltage needed to operate the graphics processing system 100 at a frequency indicated by the frequency setting 131. (Higher voltage allows circuits to operate at higher frequency, which result in higher performance metric via higher data throughput and/or lower latency, but also higher power consumption).

The graphics processing system 100 adaptively adjusts the performance settings to the performance controller 130 based on events reported by the event reporter 140. In some embodiments, the power manager 110 receives the identity of a reported event and a time stamp associated with the event from the event reporter 140 and determines whether the performance settings provided to the performance controller 130 is adequate (not too fast or too slow). In some embodiments, the event reporter 140 is configurable, i.e., the types of events that are to be monitored and/or reported can be configured by the user to suit the type of application running on the CPU and the GPU.

The frame analyzer 120 collects status, data, or reports from various modules or circuits in the graphics processing system 100 and provide the collected data to the power manager. The modules or circuits from which the status is collected can include one or more of the following: a CPU, a GPU, a memory device, a display device, bus fabric, and other types of circuits that together constitute the graphics processing system 100. The collection of status can include signals sent directly by the various circuits of the graphics processing system 100 and/or data stored in memory structures that are readable by the power manager 110. Data or status bits collected from these devices are provided to the power manager 110 as indicators for deriving scene information in order to determine the performance settings (at the performance controller 130).

The power manager 110 uses some of the status data collected as “early indicators”, because they are indicative of upcoming graphical processing workload of an upcoming frame. The early indicators of a frame are therefore status data that are available for predicting the graphical processing workload of the frame before the start or soon after the start of the graphical processing of the frame (e.g., before or soon after a start of frame event such as vertical synchronization, or VSYNC). Such early indicator can include status data related to CPU processes and/or memory accesses for the upcoming frame.

The performance controller 130 controls a collection of control data or signals to various modules or circuits in the graphics processing system 100. The modules or circuits can include one or more of the following: a CPU, a GPU, a memory device, a display device, bus fabric, and other types of circuits that together constitute the graphics processing system 100. The control data can include signals sent by the power manager 110 directly to the various circuits of the graphics processing system 100 and/or control data stored in memory structures by the power manager 110. The performance controller 130 handles control data or signals that control the performance of circuits and/or devices in the graphics processing system. The performance controller 130 controls settings that control clock frequency (e.g., frequency setting 131) and operating voltage (e.g., voltage setting 132). The performance controller 130 also controls settings that control display frame rate, display response time to user interaction, or other settings that may affect the performance or the power usage of the graphics processing system 100. In some embodiments, a set of performance settings can be said to achieve a particular performance metric (e.g., a particular operating frequency or a particular data rate).

The event reporter 140 reports the occurrence of certain types of events or operational steps at the graphics processing system 140 to the power manager 110. The power manager 110 uses the reported events to determine whether the performance settings provided to the performance controller 130 are adequate. To report an event, the event reporter 140 in some embodiments provides an identity for the event together with a timestamp marking the time of the occurrence of the event. The power manager 110 in turn re-estimates the level of scene change at the event and decides whether to adjust the performance settings in a fine-grain fashion based on the re-estimated level of scene change.

The performance LUT 150 is a lookup table for mapping scene information from the framer analyzer 120 into performance settings to the performance controller 130. The performance LUT 150 may include entries for directly mapping scene information to performance settings. The performance LUT 150 may also include entries for mapping derived parameters to the performance settings. For example, the power manager 110 computes a level of scene change from the scene information as a parameter to lookup performance settings. (The level of scene change is a measure of difference between the scene information of a previous frame or scene and the scene information of the current frame or scene.)

The power manager 110 is a module that determines the level of performance settings to the performance controller 130 based on the information supplied by the frame analyzer 120. In some embodiments, the power manager 110 is a software module that is operating in a set of processing units in the graphics processing system 100. The set of process units operating the power manager can be a CPU, a GPU, or another processing unit constituting the graphics processing system.

In some embodiments, the scene information includes a set of early indicators. The power manager 110 compares the early indicators of the current frame with the early indicators of a previous frame to determine a level of scene change and to assign a set of initial performance settings based on the determined level of scene change. The power manager uses the assigned set of initial performance settings to set the performance of the graphics processing system 100 before the start of a frame. In some embodiments, if the level of scene change is sufficiently small (i.e., amount of scene change between the current frame and the previous frame is less than a threshold), the power manager 110 would increment or decrement the performance settings from the previous frame by a small amount (or keep the performance settings the same) as the initial performance of the new current frame.

One the other hand, if the level of scene change is sufficiently large (i.e., amount of scene change between the current frame and the previous frame is greater than a threshold), the power manager would provide performance settings that significantly boost the performance of the graphics processing system 100. This is because the greater the level of scene change, the greater the uncertainty as to the actual amount of processing that will be needed to process the frame. By over-estimating the performance needed to complete the processing, the power manager minimizes the risk of failure when processing the current frame.

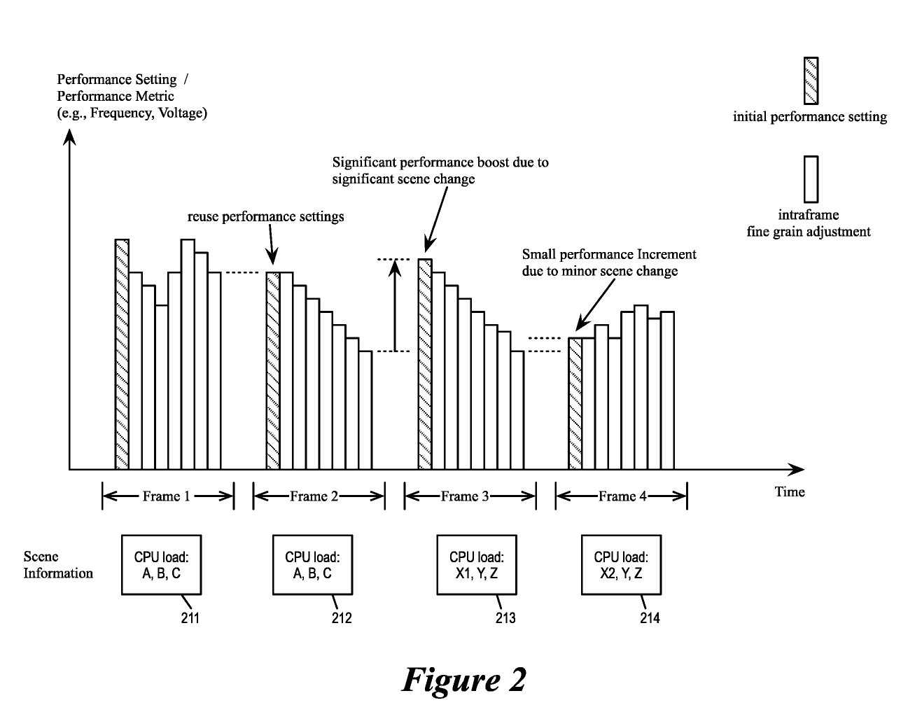

FIG. 2 illustrates the adjustment or the setting of performance in the graphics processing system 100 by its power manager 110. The figure shows the setting of performance levels during the processing of four consecutive frames (frames 1 through 4). As illustrated, at the beginning of each frame, the power manager provides sets the performance of the graphics processing system according to an initial performance settings (shaded). As the graphics processing system proceeds along the processing of a frame, the power manager provides fine-grain adjustment of the performance (unshaded).

As mentioned, the setting of the initial performance settings is based on a comparison of early indicators between the current frame and the previous frame. FIG. 2 conceptually illustrates early indicators of each frame (early indicators 211-214 for frames 1 through 4, respectively). In the example, the initial performance settings of frame 2 is based on a comparison between the early indicators of frame 2 and the early indicators of frame 1, the initial performance settings of frame 3 is based on a comparison between the early indicators of frame 3 and the early indicators of frame 2, the initial performance settings of frame 4 is based on a comparison between the early indicators of frame 4 and the early indicators of frame 3, etc.

As illustrated, the power manager uses the performance settings for frame 1 as the initial performance settings of frame 2. This is because the early indicator 211 of frame 1 and the early indicator 212 of frame 2 are very similar (both have CPU loads for tasks A, B, and C). The power manager also uses the performance settings for frame 3 as frame 4, with a little increment. This is because the early indicator 213 of frame 3 and the early indicator 214 of frame 4 are similar (both have CPU loads for tasks Y and Z, though the early indicator 214 also has CPU load for task X2 instead of X1.) For frames 2 and 4, the computed level of scene change is small enough such that the power manager can continue to use the performance settings of the previous frames as the initial performance settings of the current frame.

On the other hand, the power manager assigns a boosted performance as the initial performance settings for frame 3. This is because the early indicator 213 of frame 3 differs significantly with the early indicator 212 of frame 2 (the early indicator of frame 2 has CPU loads for tasks A, B, and C, while the early indicator for frame 3 has CPU loads for tasks X1, Y, and Z). For frame 3, the computed level of scene change is too large, such that the power manager cannot continue to use the performance settings of the previous frame as the initial performance settings of the current frame. In fact, the power manager cannot be certain what is the proper initial performance setting, and so it boosts the initial performance settings to a level that is likely to be sufficient in view of the uncertainty.

In some embodiments, the power manager quantifies the level of scene change. When the quantified change is greater than a particular threshold, the power manager boosts the initial performance settings of the frame to achieve a boosted performance metric that is greater than the performance metric of the previous frame by a particular amount. When the quantified change is less than the particular threshold, the power manager sets the initial performance settings of the current frame by adjusting the performance settings from the previous frame by the particular amount.

In some embodiments, the boosted initial performance is a set of values that are assigned based on the level of scene change (i.e., the difference between the early indicators). In some embodiments, the boosted initial performance is a set of predefined values that are entirely independent of the level of scene change and of the performance settings of the previous frame. In some embodiments, the boosted initial performance is greater than the performance metrics of the previous frame by a particular amount.

As illustrated, following the initial performance settings of each frame, the power manager adjusts the performance settings further in a fine-grained fashion. In some embodiments, the power manager re-evaluates or re-estimates the level of scene change at certain event or operational steps (e.g., reported by the event reporter 140). Upon occurrence of these steps or events, the power manager compares the scene information with a set of previously recorded scene information (or early indicators) to re-estimate the level of scene change. This previously recorded scene information can be scene information of a previous frame, or of a previous event or operational step. The power manager then uses the re-estimated level of scene change to determine a new performance setting. In some embodiments, the re-estimated level of scene change is used as an index to lookup a set of performance settings from the performance LUT 150.

In some embodiments, each reported event or operational step is associated with a timestamp that marks the event's actual time of occurrence, and the power manager compares this actual time of occurrence with an expected time of occurrence in order to determine a fine-grain adjustment of the performance settings.

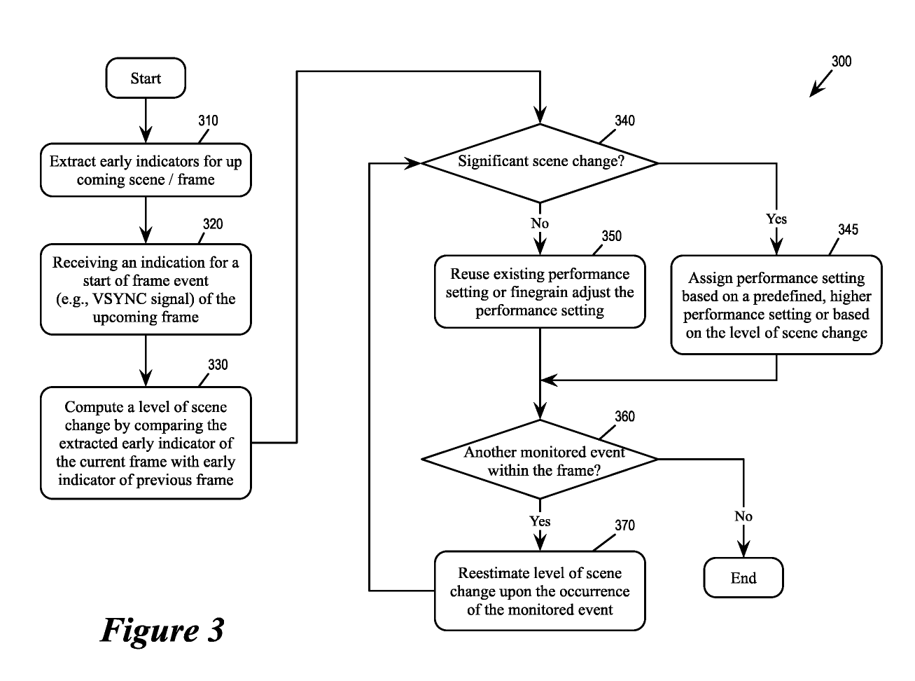

FIG. 3 conceptually illustrates a process 300 for managing power in a graphics processing system. In some embodiments, the power manager 110 performs the process 300 when controlling the performance settings to the graphics processing system. In some embodiments in which the power manager is a software module operated by the CPU or the GPU, the CPU or the GPU performs the process 300.

The process 300 starts by extracting (at 310) early indicators for an upcoming frame, which contains a scene that may or may not have significant changes from the previous frame. These early indicators are part of scene information received from various components of the graphics processing system. The process also receives (at 320) an indication for a start of frame event, e.g., the VSYNC signal of the upcoming frame. Upon reception of the VSYNC signal, the upcoming frame becomes the “current frame”.

After receiving the start of frame event indication, the process computes (at 330) a level of scene change by comparing the extracted early indicator of the current frame with early indicator of the previous frame. The process in some embodiments quantifies this level of scene change as a value or a set of values.

Based on the computed level of scene change, the process determines (at 340) whether the level of scene change is significant or merely incremental, e.g., whether the quantified level of scene change is greater than a particular threshold. In some embodiments, significant scene change can be detected by vertex number, different draw call, different number of layers rendered, and extra event or process kicked. If the scene change is significant, the process proceeds to 345. If the quantified level of scene change is not significant, e.g., if the quantified level of scene change is less than the particular threshold, the process proceeds to 350.

At 345, the process assigns performance settings based on a set of predefined, higher (i.e., boosted) performance settings. The power manager uses this boosted performance settings because high level of scene change means it is more difficult to predict the optimal performance settings based on existing performance settings (the actual performance settings required can be much higher than the existing performance settings). The power manager therefore boosts the performance settings to be above an uncertainty threshold. In some embodiments, the boosted performance settings are predefined values that are independent of the current performance settings. In some embodiments, the power manager adds a predefined boost value to the current performance settings to arrive at the boosted performance settings. After assigning the boost performance settings, the process proceeds to 360.

At 350, the process reuses the existing performance settings or adjusts performance settings in a fine grain manner. At this operation, the process has determined that there is very little scene change between this frame and the previous frame, and therefore it is likely that existing performance settings (the setting that has been applied to the previous frame or previously for the current frame) is still the most optimal setting. The power manager therefore reuses the current performance settings, or increments/decrements the performance settings by a small amount that is below a fine-grain threshold (the fine-grain threshold is smaller than the uncertainty threshold of operation 345). The process then proceeds to 360.

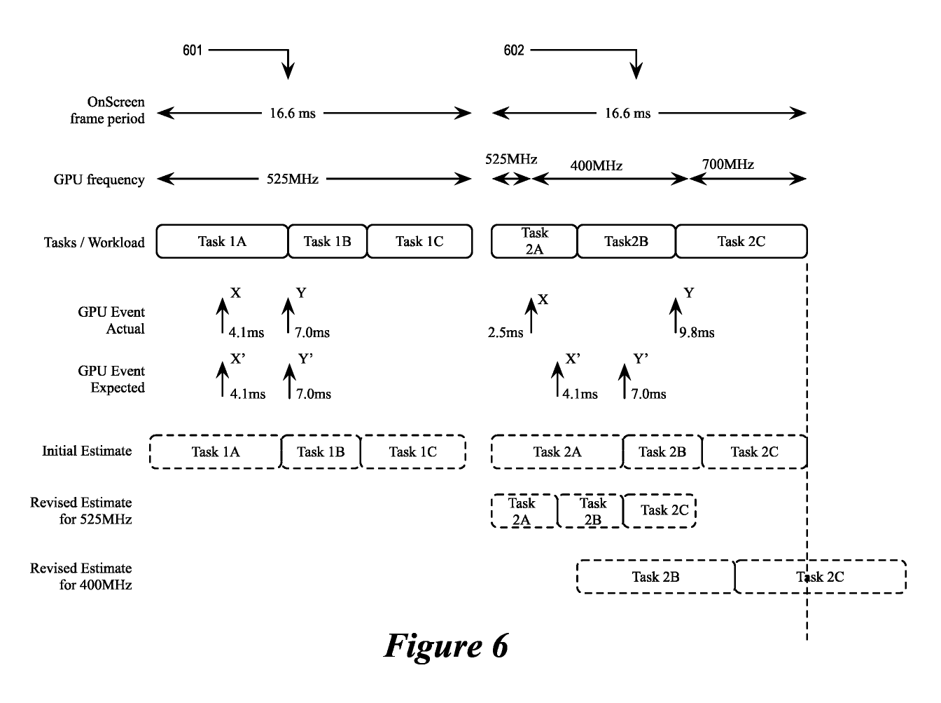

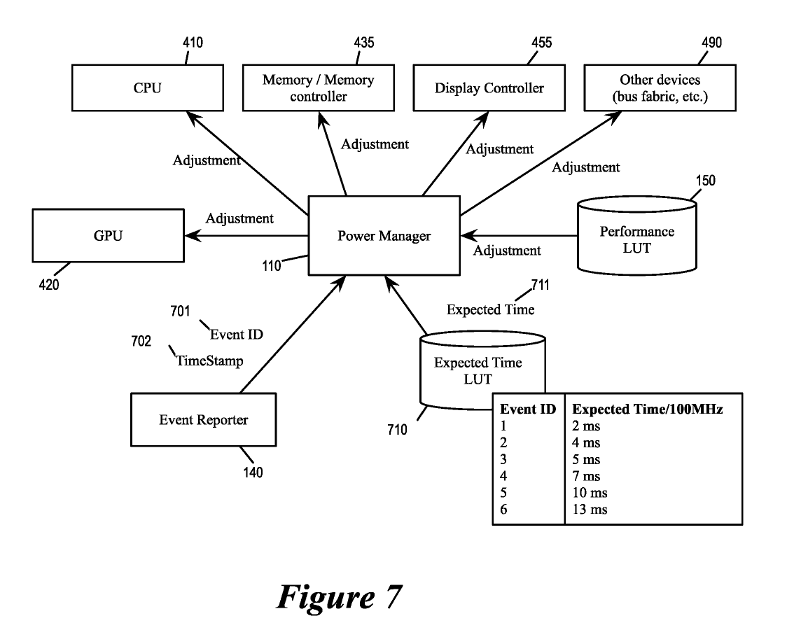

In some embodiments, the magnitude of the fine-grain adjustment of the performance settings is based on the level of scene change. In some embodiments, the fine-grain adjustment is based on an examination of the adequacy of performance. The process receives reported events or operational steps (from event reporter 140) together with a timestamp for the occurrence of the event. The process then compares the timestamp with an expected time for the event to determine if the performance settings are too high or too low, and thereby decides whether to increment or decrement the performance settings. Using timestamps of reported event to fine-grain adjust performance settings will be further described by reference to FIGS. 6-7 described below.

At 360, the process determines if there is another reported event within the frame at which the power manager should determine whether to set or adjust performance settings. The first event of the frame at which the power manager sets or adjusts performance settings is the VSYNC event marking the start of frame. However, the power manager can monitor other events or operational steps during the frame and perform re-evaluation and fine grain adjustment upon the occurrence of those events. An example of such an event is when a GPU has completed drawing N number of triangles or pixels. If there is another such monitored event in the frame, the process proceeds to 370. Otherwise the process ends.

At 370, the process re-estimates the level of scene change at the occurrence of the monitored event by comparing the scene information with a previous version of the scene information, or by comparing the scene information with the scene information of the previous frame. (This operation is similar to that of operation 330 which compares early indicators between the upcoming frame with the early indicators of the previous frame). The process then proceeds to 340.

As mentioned, in some embodiments, a graphics processing system includes a CPU, a GPU, a set of memories, and a display device. Its power manager performs scene-aware power management by using data produced by these devices as scene information and by controlling the performance settings of these devices.

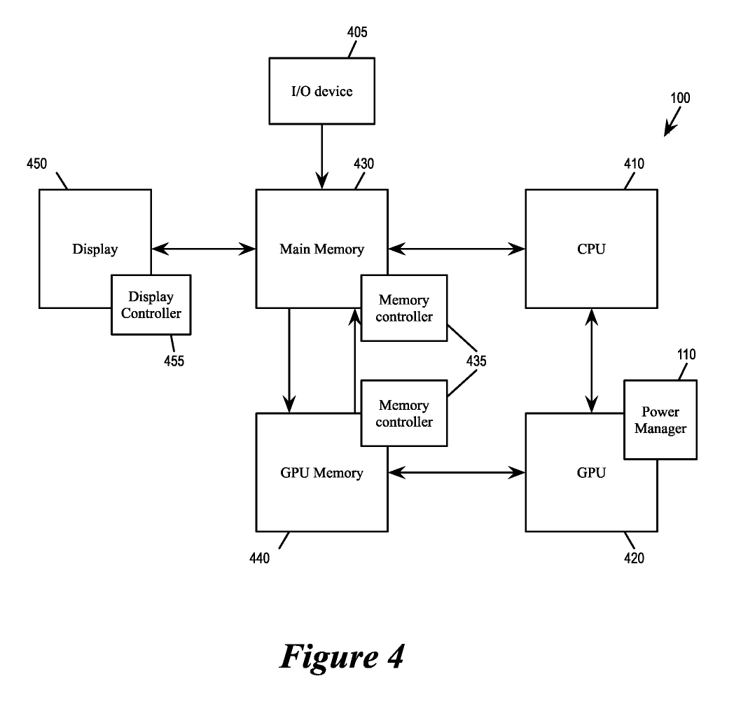

FIG. 4 is a block diagram of the graphics processing system 100 that includes CPU, GPU, memory, and display devices. The graphics processing system performs scene-aware power management by using data from CPU, GPU, memory, and display device as scene information.

As illustrated, the graphical processing 100 circuit includes a CPU 410, a GPU 420, a main memory 430, a GPU memory 440, and a display device 450. A set of memory controllers 435 controls the main memory 430 and the GPU memory 440. A display controller 455 controls the display device 450. The scene-aware power manager 110 is illustrated as being a software or hardware module operating at the GPU 420, but it can also be a software module operated by the CPU 410. These components are interconnected by various circuit components that are collectively referred to as the bus or the bus fabric (not illustrated).

In some embodiments, the CPU 410, the GPU 420, the main memory 430, the GPU memory 440, the memory controller 435 and the display controller 455 are modules of hardware circuits implemented by one or more integrated circuits (ICs) of an electronic apparatus. For example, in some embodiments, the main memory 430 and the GPU memory 440 are implemented as physical memory device, while the memory controllers 435, the display controller 455, the CPU 410, the GPU 420, and the power manager 110 are implemented within one IC.

As illustrated, the CPU 410 and the GPU communicates with each directly as well as through the memories 430 and 440. The set of memory controllers 435 controls the memory accesses to the main memory 430 and 440, as well as conducting direct memory access (DMA) operations for the memory structures. These DMA operations can include data transfer between the main memory 430 and the GPU memory 440, between the GPU 420 and the GPU memory 440, between the CPU and the main memory 430, and between the main memory 430 and the display 450 (which may have a display buffer for storing pixel data to be displayed.)

These devices of the graphics processing system 100 perform computations and operations in order to provide data to be displayed at the display device 450. For example, the graphics processing system receives data through an I/O device 405 from a mass storage device or a network and stores data at the main memory 430. Based on those stored data, the CPU 410 performs various computations tasks and/or workloads and generates processed data for the GPU 420 to process into graphics to be displayed at the display device 450. The power manager 110 uses information about the workloads and tasks performed by the CPU 410 and the GPU 420 as well as information about the data generated and/or processed by the CPU 410 and the GPU 420 as scene information.

Though not illustrated, in some embodiments, the graphics processing system 100 is part of a camera system, and the graphical data produced by the system 100 is provided to an image or video encoding device.

The scene information is used to predict the optimal level of power settings for the graphics processing system, because they are indicative of the amount of workload that needs to be performed in order to generate the data necessary for display or camera recording. The scene information collected from different processes are taken together and jointly analyzed (e.g., summed) for level of scene change. The following are some examples of scene information that the power manager collects from various devices of the graphics processing system:

Application/game engine/Game physics calculation of previous scene loading;

GPU context number;

Vertex/primitive number;

Draw command number;

Vertex shading run-time and complexity;

Tessellation run-time and complexity;

Vertex distribution and covered tile numbers;

Rendering target layer number;

Rendering resolution and tile number of each layer;

Pixel Shading run-time and complexity;

Texture size/type/layer/complexity;

General GPU event counter, i.e., tile, primitive, vertex, pixel, texture, instruction . . . etc.;

API (application programming interface) type;

Temperatures of chips in the graphics processing system;

CPU loading (pre-processing, etc., before next scene, API calls);

Bandwidth/DRAM latency/cache hit rate;

VSYNC event (vertical synchronization separating the video fields.); and

External user event.

As mentioned, the power manager uses some of the scene information collected as early indicators in order to determine a set of initial performance settings for the start of each frame. The following are examples of scene information that are used as early indicators:

CPU Loading of Application/game engine/Game physics calculation;

API trace of GPU rendering/compute standard (OpenGL, OpenCL, Vulkan, etc.), including attribute, state and parameter of each API function call;

Vertex Shading run-time and complexity;

Tessellation run-time and complexity;

Tile list—covered tile numbers;

Rendering target layer number;

Resolution and total tile number of each layer;

API type;

Pixel shading run-time and complexity;

Texture type, size, layer, run-time, and complexity;

User interface event; and

Number of displays.

In some embodiments, the power manager provides performance settings to various components of the graphics processing system in order to achieve specific performance metrics, such as a particular operating frequency (in order achieve a particular data rate or latency). A set of performance settings may include performance settings to various components, modules, or circuits in the graphics processing system. In other words, a set of performance settings may include frequency and voltage settings to the CPU 410, frequency and voltage settings to the GPU 420, frequency and voltage settings to the bus fabric, etc. In some embodiments, performance settings to a particular module or circuit of the graphics processing system 100 may include other settings that impact performance. For example, the performance settings to the display 450 (or the display controller 455) may include settings that control frame rate, display response time to user interaction (also referred to as “display deadline”), as they also affect the power consumption of the graphics processing system; the performance settings to the CPU 410 may also include specification on how many cores to use.

The following are examples of performance settings that are controlled by the scene-aware power manager: (as initial performance settings or fine-grain adjustment)

Switch of power source of the GPU or its sub-instances;

Slow-down/speed-up of GPU/CPU and its sub-instance frequency and voltage;

Early wake-up or early speed-up of devices (CPU, GPU, etc.);

Adjustment of memory bandwidth and arbitration policy (e.g., the main memory 405 and/or the GPU memory 440); and

Display frame-rate and deadline strategy.

In some embodiments, the fine-grain adjust of performance settings includes budget and step and correction. Such budget and step correction can be applied to some or all of the following settings of the graphics processing system:

Switch external shader/sub-modules/SRAM power source PMIC/LDO/MTCMOS;

Slow down/speed-up active shaders/sub-module/SRAM frequency and even voltage;

Early wake-up or early speed-up by prediction to reduce performance drop;

CPU loading allocation for GPU process;

DRAM bandwidth allocation; and

Display strategy and deadline policy.

As mentioned, the power manager monitors other events or operational steps during the frame (i.e., after start of the frame) and perform re-evaluation and fine grain adjustment upon the occurrence of those events. The following are examples of events or operational steps being monitored by the power manager (e.g., through the event reporter 140) for purpose of adjusting performance settings:

Events Occurring at CPU:

CPU loading of GPU application;

Events Occurring During Vertex Shading Phase (at GPU):

Primitive processing performance;

Number of Primitive Phase kicked;

Shading instruction counter;

Events Occurring During Pixel Shading Phase (at GPU):

Number of Layer be rendered;

Tile processing performance of each layer;

Shading instruction counter; and

MSAA type.

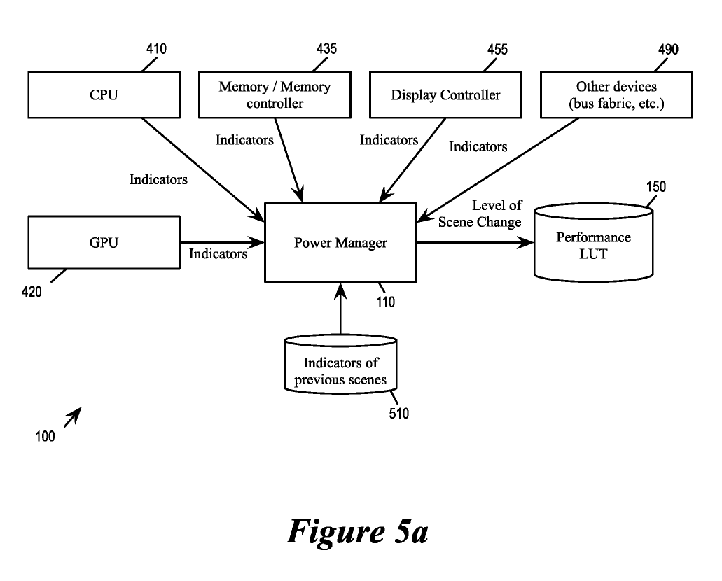

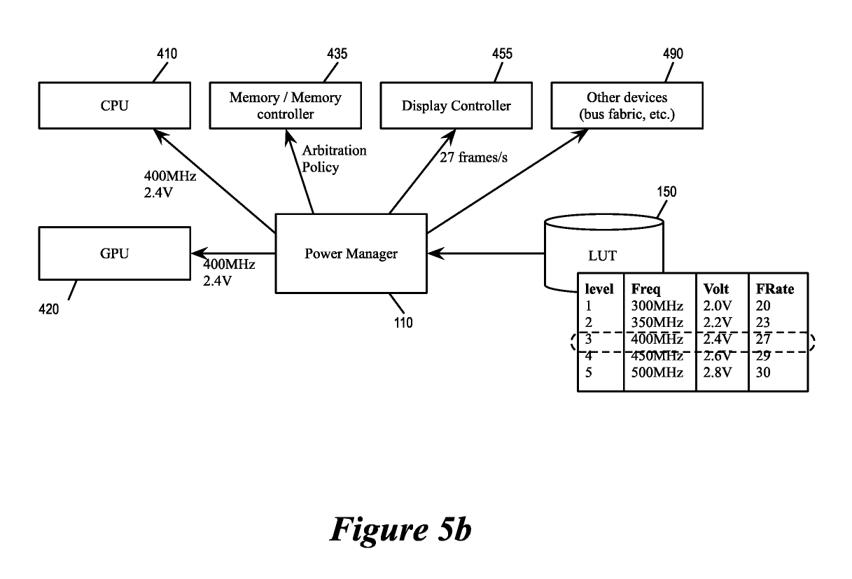

As mentioned, in some embodiments, the power manager uses a LUT to look up performance settings based on scene information (including early indicators.) FIGS. 5a-b illustrates the flow of data in the graphics processing system 100 when using the performance LUT 150 to lookup performance settings for various devices.

As illustrated in FIG. 5a, the power manager 110 receives scene information and/or indicators (including early indicators) from the CPU 410, the memory controllers 435, the display controller 455, the GPU 420, as well as other devices 490 that includes bus fabric components. The power manager 110 uses the received scene information to look up a performance settings from the LUT 150. To generate the initial performance setting, the power manager compares the early indicators of the upcoming frame with the early indicators of the previous frame (illustrated as being stored in a storage 510) and quantifies the difference as “level of scene change”.

As illustrated in FIG. 5b, the power manager uses the level of scene change as an index to lookup the LUT 150 and retrieves a set of performance settings, including frequency, voltage, and frame rate. In the illustrated example, the quantified level of scene change is “3”, and the LUT correspondingly produces a set of performance settings that includes frequency of 400 MHz, voltage of 2.4V, and frame rate of 27 per second. As mentioned, a set of performance settings can have many more parameters, such as different sets of frequencies and voltages for multiple different circuits or modules, as well as parameters such as display response deadline, memory access arbitration policy, etc.

As mentioned, the power manager not only supplies an initial performance settings for each frame based on the frame's early indicators, but also performs fine-grain adjustment of the performance settings for the processing of frame after the processing of the frame has already started. In some embodiments, such adjustments take place at specific events during the processing of the frame by the GPU. The power manager uses these events to evaluate the adequacy of the performance settings and adjusts accordingly. In some embodiments, the graphics processing system includes an event reporter such as the event reporter 140 to report these events, by e.g., reporting the identity of each event together with a timestamp for the occurrence of the event. The power manager 110 in turn uses the reported event and timestamp to identify an expected time for the event in order to determine if the performance settings are too high or too low. For example, the power manager 110 in some embodiments monitors the GPU for when it completes computing 10,000 triangles for a frame. The power manager 110 uses the timestamp associated with the event to determine how quickly the GPU finishes the task and whether to increase performance or decrease performance based on a comparison between the timestamp and an expected run-time for the event.

FIG. 6 illustrates fine-grain adjustment of performance settings for processing a frame based on timestamps of monitored events. The figure illustrates the adjustment performance settings during two consecutive frames 601 and 602, specifically when these two frames are processed by the GPU 420 for display or for camera recording.

As illustrated, the GPU is operating at frequency of 525 MHz when processing the frame 601. This frequency may be inherited from a previous frame because its early indicators are identical or similar to the previous frame. This frequency may also be a set of boosted performance settings due to a level of scene change that is considered too large.

The power manager monitors several GPU events, including events “X” and “Y” (which may correspond to, say, GPU completing rendering 10,000 triangles). The GPU event “X” is expected to occur at 4.1 ms mark (after the start of frame) and the GPU event “Y” is expected to occur at 7.0 ms mark. These expected times are predicted based on the GPU frequency 525 MHz and the workload of the GPU during the frame 601. The actual occurrence of the GPU events X is 4.1 ms and the actual occurrence of the GPU event Y is 7.0 ms, which are identical (or very close) to their respective expected times. The power manager therefore determines that the workloads are being processed at nearly optimal rate and holds the performance settings at 525 MHz. The workloads 1-A, 1-B, and 1-C are finished at nearly end of the frame, affirming that the performance settings from the GPU is near optimal for the frame 601.

The GPU starts the frame 602 at the frequency 525 MHz, which is inherited from the processing of the frame 601 because its early indicators are identical or similar to the frame 601. The GPU is going to have several workloads (Tasks 2-A, 2-B, and 2-C). Based on these workloads and the frequency 525 MHz, the performance manager determined that the expected time for event X to be 4.1 ms and event Y to be 7.0 ms.

As the GPU processes the frame 601, the actual time for event X turned out to be 2.5 ms, meaning the GPU is running faster than necessary (“revised estimate for 525 MHz” showing workloads 2A-2C completing too early) and can slow down a bit to reduce power consumption. The power manager therefore reduces the GPU frequency to 400 MHz. The GPU then proceed to operate with 40 MHz frequency until it encounters event Y at 9.8 ms, which was expected to arrive earlier 7.0 ms. In other words, the GPU is operating too slow and may not finish the workloads on time with the frequency at 400 MHz (“revised estimate for 400 MHz” predicting workloads 2B and 2C would not finish on time). The power manager therefore boosts the performance settings of the GPU to 700 MHz in order to finish the tasks on time.

FIG. 7 illustrates the data flow in the graphics processing system 100 when it performs fine-grain performance settings adjustment based on event timestamps. As illustrated, the event reporter 140 reports the detected event (e.g., the GPU having completed 10,000 triangles) to the power manager 110 by sending an event identifier 701 and a timestamp 702 of the event. (In some embodiments, the power manager supplies the timestamp when it receives a reported event). The timestamp of the event allows the power manager to identify the actual time of the event. The power manager 110 then uses the received event ID 701 to lookup an expected time for the event (illustrated as an expected time 711 retrieved from a lookup table 710). The power manager 110 compares the expected time 711 with the actual time based on the timestamp 702 for the event to determine whether the event is within an acceptable threshold of the expected time. If not, the power manager sends adjusted performance settings to the various circuits of the graphics processing system 100, including the CPU 410, the GPU 420, the memory controller 435, and display controller 455, and other devices 490. In some embodiments, the amount of the fine-grain adjustment is provided by the performance LUT 150 by a lookup based on the event ID 701 and the difference between the actual time 702 and the expected time 711 of the event.

In some embodiments, the content of the various lookup tables (including the performance LUT 150 and the expected time LUT 710) are dynamically adjustable based on scene information. For example, the power manager 110 can update the content of performance LUT 150 with better performance settings as it performs fine grain adjustment for various combinations of scene information or early indicators. The power manager also updates the content of the expected time LUT 710 as it learns the actual time it takes to reach certain specific events at certain specific performance setting.

### Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

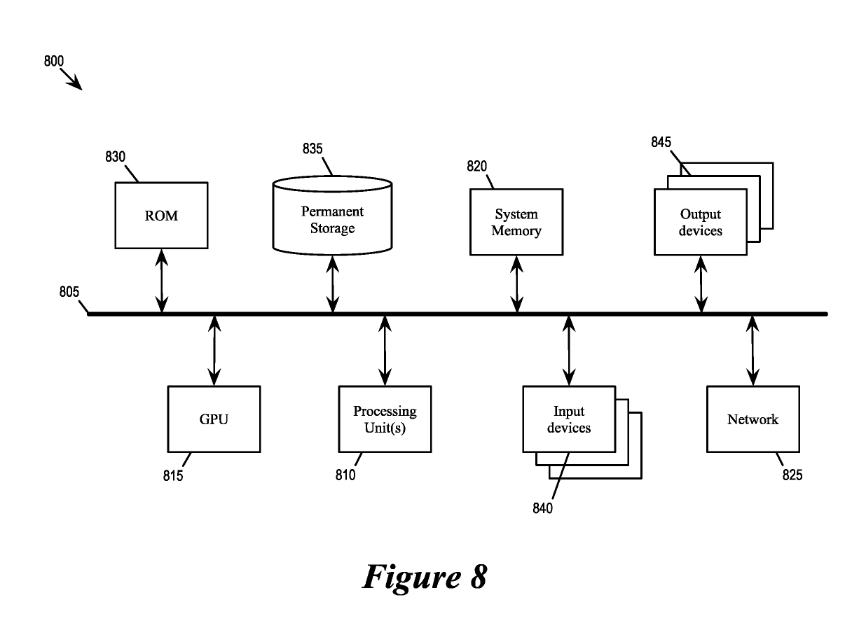

FIG. 8 conceptually illustrates an electronic system 800 with which some embodiments of the present disclosure are implemented. The electronic system 800 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 800 includes a bus 805, processing unit(s) 810, a graphics-processing unit (GPU) 815, a system memory 820, a network 825, a read-only memory 830, a permanent storage device 835, input devices 840, and output devices 845.

The bus 805 collectively represents all system, peripheral, and chipset buses that communicatively connect the numerous internal devices of the electronic system 800. For instance, the bus 805 communicatively connects the processing unit(s) 810 with the GPU 815, the read-only memory 830, the system memory 820, and the permanent storage device 835.

From these various memory units, the processing unit(s) 810 retrieves instructions to execute and data to process in order to execute the processes of the present disclosure. The processing unit(s) may be a single processor or a multi-core processor in different embodiments. Some instructions are passed to and executed by the GPU 815. The GPU 815 can offload various computations or complement the image processing provided by the processing unit(s) 810.

The read-only-memory (ROM) 830 stores static data and instructions that are needed by the processing unit(s) 810 and other modules of the electronic system. The permanent storage device 835, on the other hand, is a read-and-write memory device. This device is a non-volatile memory unit that stores instructions and data even when the electronic system 800 is off. Some embodiments of the present disclosure use a mass-storage device (such as a magnetic or optical disk and its corresponding disk drive) as the permanent storage device 835.

Other embodiments use a removable storage device (such as a floppy disk, flash memory device, etc., and its corresponding disk drive) as the permanent storage device. Like the permanent storage device 835, the system memory 820 is a read-and-write memory device. However, unlike storage device 835, the system memory 820 is a volatile read-and-write memory, such a random access memory. The system memory 820 stores some of the instructions and data that the processor needs at runtime. In some embodiments, processes in accordance with the present disclosure are stored in the system memory 820, the permanent storage device 835, and/or the read-only memory 830. For example, the various memory units include instructions for processing multimedia clips in accordance with some embodiments. From these various memory units, the processing unit(s) 810 retrieves instructions to execute and data to process in order to execute the processes of some embodiments.

The bus 805 also connects to the input and output devices 840 and 845. The input devices 840 enable the user to communicate information and select commands to the electronic system. The input devices 840 include alphanumeric keyboards and pointing devices (also called “cursor control devices”), cameras (e.g., webcams), microphones or similar devices for receiving voice commands, etc. The output devices 845 display images generated by the electronic system or otherwise output data. The output devices 845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 8, bus 805 also couples electronic system 800 to a network 825 through a network adapter (not shown). In this manner, the computer can be a part of a network of computers (such as a local area network (“LAN”), a wide area network (“WAN”), or an Intranet, or a network of networks, such as the Internet. Any or all components of electronic system 800 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 3) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
processing a first frame by providing control settings to a first set of devices to achieve a first performance metric;
receiving scene information from a second set of devices regarding a second frame after the first frame;
quantifying a change between the first frame and the second frame;
adaptively adjusting the control settings in response to a comparison of the quantified change and a predetermined threshold; and
processing the second frame by providing the adjusted control settings to the first set of devices.

2. The method of claim 1, wherein quantifying a change between the first frame and the second frame comprises comparing a set of early indicators of the first frame and a set of early indicators of the second frame, wherein the set of early indicators of a frame comprises status data that are available for predicting a graphical processing workload of the frame before a start of frame event.

3. The method of claim 1, wherein:
when the quantified change is greater than a particular threshold, adjusting the control settings to the first set of devices to achieve a second performance metric that is greater than the first performance metric by a particular amount; and
when the quantified change is less than the particular threshold, adjusting the control settings to the first set of devices based on a third performance metric that differs with the first performance metric by less than the particular amount.

4. The method of claim 1, wherein the control settings comprise a frequency and a voltage to supporting operating the first set of devices at the frequency.

5. The method of claim 1, wherein the first set of devices comprises a graphical processing unit (GPU).

6. The method of claim 1, wherein the second set of devices comprises a central processing unit (CPU), a memory control unit, and a graphical processing unit (GPU), wherein the scene information comprises a set of data generated by the GPU and the CPU.

7. The method of claim 1, wherein the scene information comprises at least one of:
central processing unit (CPU) loading of application/game engine/game physics calculation;
application programming interface (API) trace of graphical processing unit (GPU) rendering/computing standard;
vertex shading run-time and complexity;
tessellation run-time and complexity;
tile list—covered tile numbers;
rendering target layer number;
resolution and total tile number of each layer;
API type;
pixel shading run-time and complexity;
texture type, size, layer, run-time, and complexity;
user interface event; and
number of displays.

8. The method of claim 1, further comprising:
detecting a particular event at a graphical processing unit (GPU) when the GPU is processing the second frame;
identifying a fourth performance metric based on the detected event; and
adjusting the control settings to the first set of devices to achieve the fourth performance metric.

9. The method of claim 8, wherein the detected event is associated with a time stamp, wherein identifying the fourth performance metric comprises comparing the time stamp with an expected time for the particular event.

10. The method of claim 8, wherein detecting the particular event comprises monitoring an event occurring during CPU loading, an event occurring during Vertex Shading Phase at a GPU, and an event occurring during Pixel Shading Phase at the GPU.

11. The method of claim 1, wherein processing the second frame for display further comprises receiving scene information from the second set of devices regarding the second frame and adjusting the control settings to the first set of devices based on the received scene.

12. The method of claim 1, wherein the second performance metric is a predefined value that is independent of the quantified change.

13. The method of claim 1, wherein the second performance metric is a predefined value that is identified based on the quantified change but not the first performance metric.

14. A method, comprising:
processing a frame by providing control settings to a set of devices to achieve a first performance metric;
detecting a particular event at a graphical processing unit (GPU) when the GPU is processing the frame;
identifying a second performance metric based on the detected event; and
adjusting the control settings to the set of devices to achieve the second performance metric.

15. The method of claim 14, wherein the control settings provided to achieve the first performance metric is based on a set of early indicators for the frame comprising status data that are available for predicting a graphical processing workload of the frame before a start of frame event.

16. The method of claim 14, wherein the detected event is associated with a timestamp, wherein identifying the second performance metric comprises comparing the timestamp with an expected time for the particular event.

17. The method of claim 14, wherein the control settings comprise a frequency and a voltage to supporting operating the set of devices at the frequency.

18. The method of claim 14, wherein the first performance metric is identified based on a set of scene information of the frame, the set of scene information comprises at least one of:
central processing unit (CPU) loading of application/game engine/game physics calculation;
application programming interface (API) trace of graphical processing unit (GPU) rendering/computing standard;
vertex shading run-time and complexity;
tessellation run-time and complexity;
tile list—covered tile numbers;
rendering target layer number;
resolution and total tile number of each layer;
API type;
pixel shading run-time and complexity;
texture type, size, layer, run-time, and complexity;
user interface event; and
number of displays.

19. The method of claim 14, wherein the control setting comprises at least one of:
switch of power source of the GPU or its sub-instances;
slow-down/speed-up of GPU/CPU and its sub-instance frequency and voltage;
early wake-up or early speed-up of devices including the GPU and CPU;
adjustment of memory bandwidth and arbitration policy; and
display frame-rate and deadline strategy.

20. The method of claim 14, wherein detecting the particular event comprises monitoring an event occurring during CPU loading, an event occurring during Vertex Shading Phase at a GPU, and an event occurring during Pixel Shading Phase at the GPU.

21. An apparatus, comprising:
a set of processing units;
a graphical processing unit (GPU);
a set of processing units;
a display device; and
a computer readable storage medium storing sets of instructions, wherein execution of the sets of instructions by the set of processing units configures the set of processing units to perform acts comprising:
providing control settings to the GPU and the display device to achieve a first performance metric when the GPU is processing a frame for display at the display device;
detecting a particular event at the GPU when the GPU is processing the frame;
identifying a second performance metric based on the detected event; and
adjusting the control settings to the GPU based on the second performance metric.

22. The apparatus of claim 21, wherein the detected event is associated with a time stamp, wherein the act of identifying the second performance metric comprises comparing the time stamp with an expected time for the particular event.

23. The apparatus of claim 21, wherein the control settings comprise a frequency and a voltage to supporting operating the GPU at the frequency.

24. The method of claim 21, wherein the control settings comprise a frame rate control for the display device.

25. The apparatus of claim 24 further comprises a central processing unit (CPU), wherein the set of scene information comprises a workload information of the CPU.
